(19) United States
(12) Patent Application Publication
(10) Pub. No.: US 2013/0156518 A1
(43) Pub. Date: Jun. 20, 2013

(54) Height Adjustable Overhead Drilling Apparatus

(71) Applicant: Andrew H. Ward, Castle Rock, CO (US)

(72) Inventor: Andrew H. Ward, Castle Rock, CO (US)

(21) Appl. No.: 13/692,898

(22) Filed: Dec. 3, 2012

Related U.S. Application Data
(60) Provisional application No. 61/565,798, filed on Dec. 1, 2011.

(51) Int. Cl. B23B 47/26; B23B 39/16; B23B 39/00

(52) U.S. Cl. CPC B23B 47/26; B23B 39/003; B23B 39/161
USPC 408/16; 408/117; 408/56

(57) ABSTRACT

A drilling apparatus designed used to drill multiple holes in the bottom surface of an overhead surface. The drilling apparatus includes a lower frame member and an upper frame member longitudinally aligned thereover. The lower frame member includes two vertical uprights perpendicularly aligned and attached to a lower base mounted on caster wheels. A cable attached to a winch selectively lowers and raises the upper frame member over the lower frame member. Attached to the upper end of the upper frame member is a perpendicularly aligned horizontal support member. Mounted on the support member are two or more drill brackets that hold inverted drill motors each with a drill bit at a fixed location and at a fixed angle. At least one drill bracket includes a horizontal alignment flange surface that is used as an alignment surface for a laser placed on the support surface and aimed upward to the precise hole location on the overhead surface.

This utility patent application is based upon and claims the priority filing date of U.S. provisional patent application (Application No. 61/565,798) filed on Dec. 1, 2011.

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

This invention pertains to drilling apparatus and more particularly, to drilling apparatus used to drill holes in an overhead surface.

2. Description of the Related Art

When constructing buildings made of concrete floor slabs, the various electric, plumbing and HVAC conduits and ducts are attached via brackets and straps to the overhead floor slabs. The height of an overhead ceiling slab on a building varies from one building to another and from one floor to another. The brackets and straps are connected to the overhead ceiling straps via bolts are typically attached to holes drilled in precise locations and depths into the overhead floor slabs. In some instances, hundreds of holes must be precisely drilled into the overhead slab which, heretofore, is very time-consuming.

What is needed is a drilling apparatus that can be used to precisely drill one or more holes in an overhead surface that may also vary in height.

### SUMMARY OF THE INVENTION

Disclosed herein is a drilling apparatus designed to precisely and simultaneously drill multiple holes in an overhead surface. A key feature of the drilling apparatus is the use of a length adjustable frame that includes a lower frame member and an upper frame member. The lower frame member includes two vertical uprights perpendicularly aligned and attached to a lower base mounted on caster wheels that allows the drilling apparatus to be selectively moved to a desired position on the floor directly below the overhead surface. The upper frame member includes two vertical arms that are aligned and registered with the lower frame's vertical uprights. When the upper frame is attached to the lower frame member, the upper frame member slides longitudinally from the upper end of the lower frame member thereby adjusting the overall length or height of the frame.

The drilling apparatus also includes a manual, hydraulic or electric winch disposed between the lower and upper frame member and pulley that enables the user to longitudinally slide and thereby selectively extend or retract the upper frame member over the lower frame member.

Attached to the upper end of the upper frame member is a perpendicularly aligned horizontal support member. Mounted on the support member are two drill brackets each designed to securely hold an electric drill in a perpendicular aligned, upward extending position on the support member. When two drills are attached to the two brackets, the drill bits used with two drills extend upward and are parallel and disposed at the same elevation above the support member. During assembly, the brackets may be selectively moved and locked at a desired position on the support member thereby enabling the user to adjust the spacing between the two drills. At least one drill bracket includes a horizontal alignment plate that is used with a laser pointer or plumb bob disposed vertically and aligned with a reference point indentified on the ground and aimed upward. A reference point is formed on the lower surface of the alignment plate that is aligned with the drill bit when the drill is attached to the drill bracket. By moving the drilling apparatus so that the desired reference point on the ground is vertically aligned with the drill bit, the user knows that the hole is being drilled on the overhead surface directly over the reference point.

The drilling apparatus may include an optional electrical plugs mounted on the lower and upper frames that allows the two drills, the winch motor and vacuum tank to be plugged in and supplied electricity. The vacuum tank may be connected to main and secondary vacuum tubes that collect drilling debris as it is being created while drilling.

### DESCRIPTION OF THE DRAWINGS

FIG. 1 is a left front perspective view of the drilling apparatus located on a flat surface with a laser positioned on the flat surface and aimed upward towards an alignment plate on one drill bracket with two drills mounted on two drill brackets attached to the upper support arm and also showing the upper frame section being extended upward so that the two drills may be precisely and simultaneously drill to form two holes in an overhead surface.

FIG. 2 is a right front perspective view of the drilling apparatus shown in FIG. 1 and in a retracted position with the two drills and vacuum assembly removed and showing two lasers positioned on the flat surface and aimed upward towards the two alignment plates.

FIG. 3 is an exploded left front perspective view of the drilling apparatus.

FIG. 4 rear elevational view of the drilling apparatus in a retracted position.

FIG. 5 is a top plan view of the drilling apparatus.

FIG. 6 is a left front perspective view of the drilling apparatus in an extended position.

FIG. 7 is a front elevational view of the drilling apparatus in an extended position.

FIG. 8 is a side elevational view of the drilling apparatus shown in FIG. 8.

### DESCRIPTION OF THE PREFERRED EMBODIMENT(S)

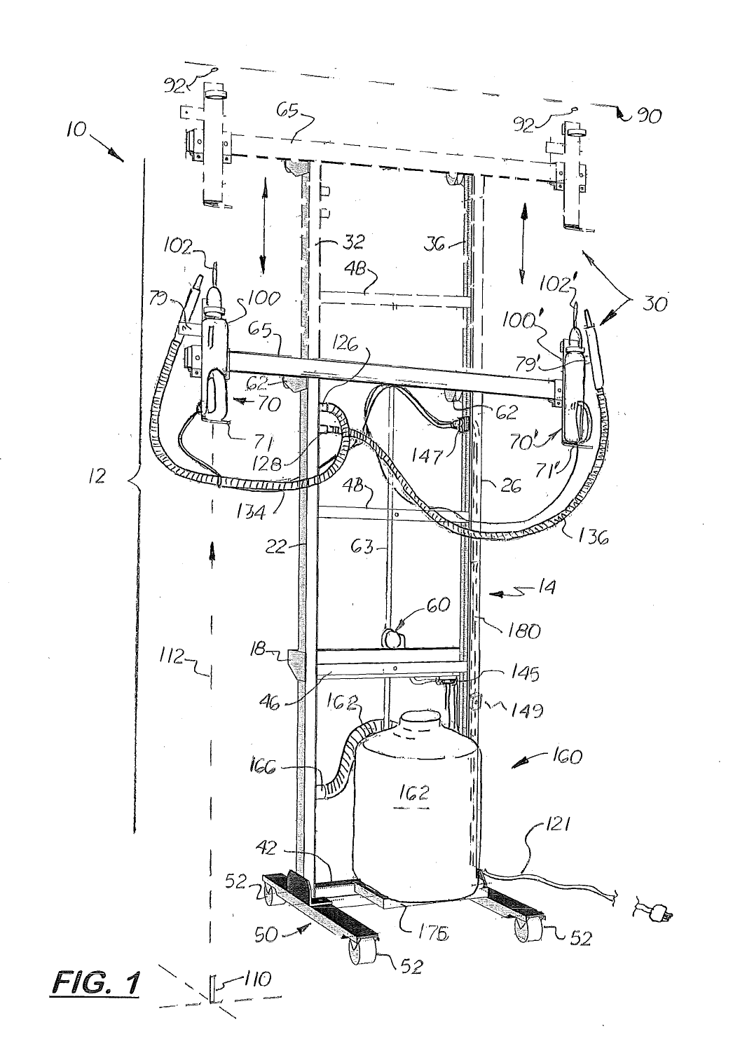

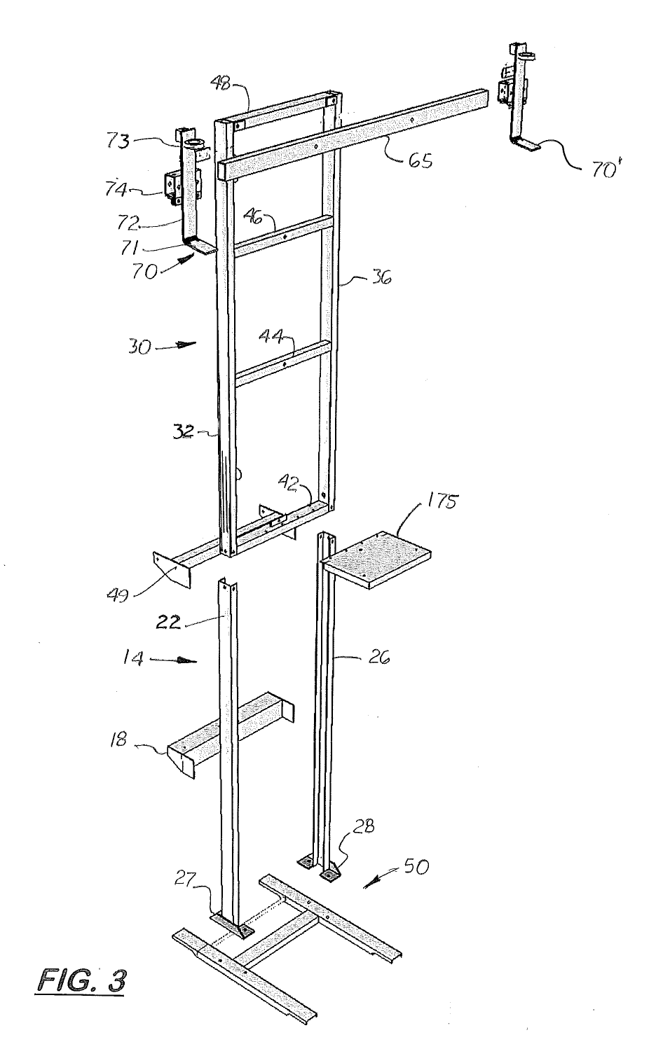

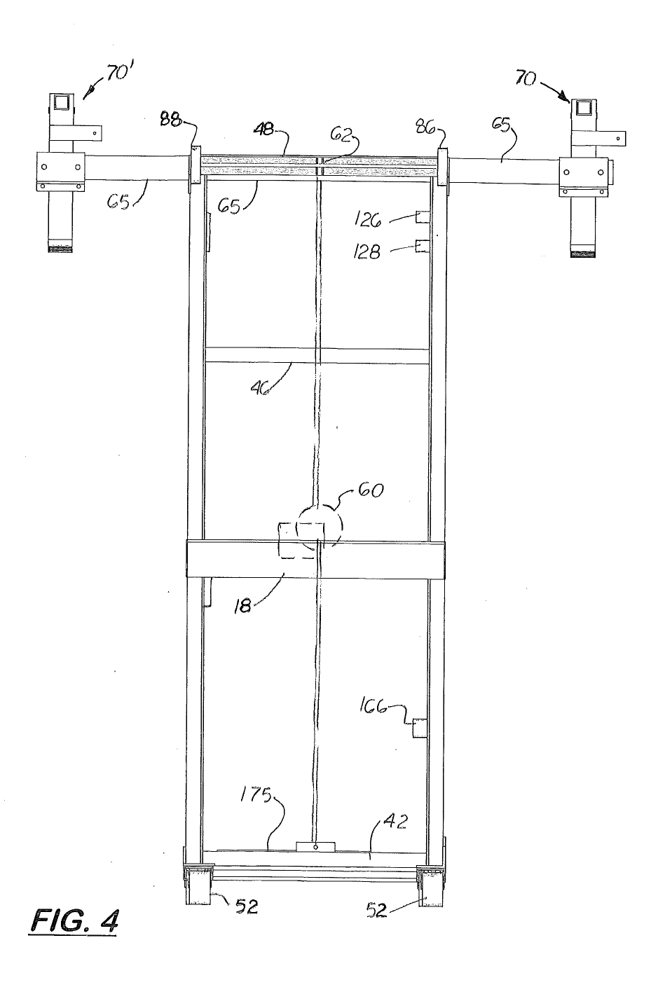

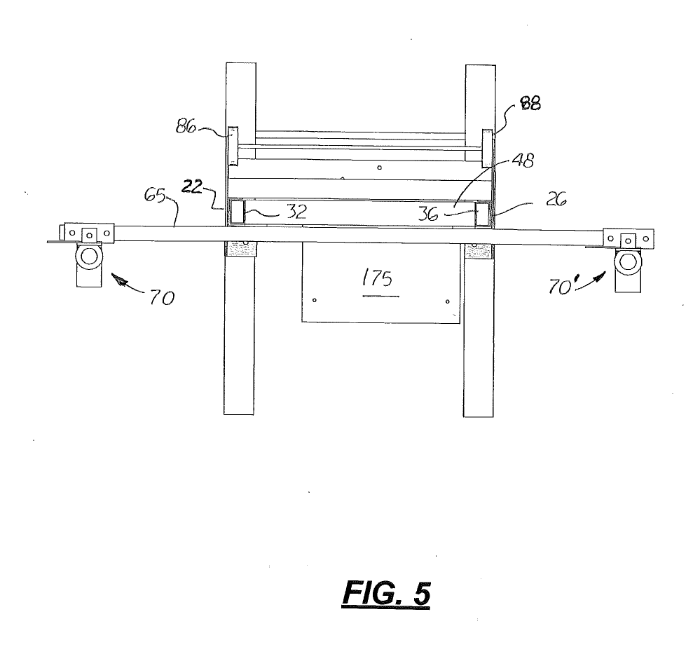

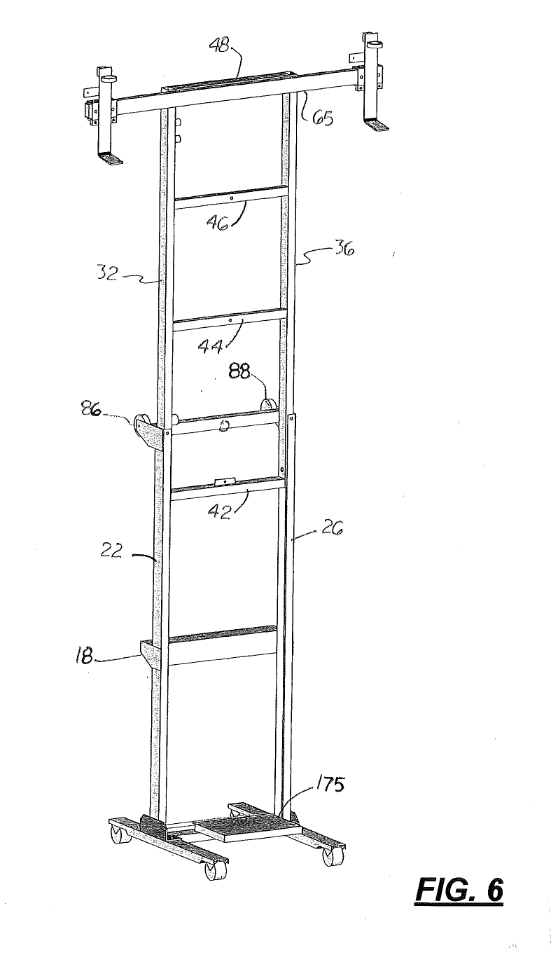

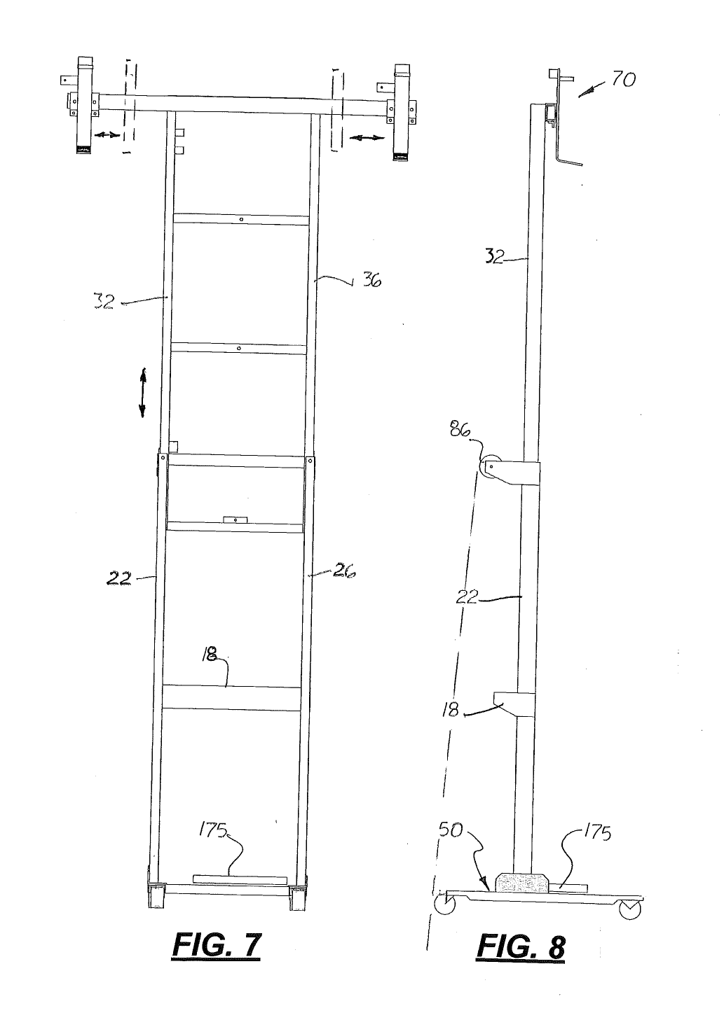

Referring to the accompanying FIGS. 1-8, there is shown a drilling apparatus 10 designed to precisely and simultaneously drill multiple holes 92 in an overhead surface 90. The drilling apparatus 10 includes a telescopic, length adjustable frame 12 that includes a lower frame member 14 and an upper frame member 30. The adjustable frame 12 operates similar to a ladder and includes a lower frame member 14 with vertical uprights 20, 26 perpendicularly aligned and attached to a lower base 50 mounted on caster wheels 52. The adjustable frame 12 also includes an upper frame member 30 includes two parallel leg 32, 36 that are aligned and registered with the lower frame's parallel uprights 22, 26, respectively. When the upper frame member 30 is attached to the lower frame member 14, the upper frame member 30 slides longitudinally from the upper end of the lower frame member 14 thereby enabling the operator to adjust the overall height of the adjustable frame 12.

The lower frame member 14 and the upper frame member 30 are design to slide longitudinally together. In the embodiment shown herein, the vertical uprights 22, 26 on the lower frame member 14 are C-shaped channels and the vertical arms 32, 36 on the upper frame member 30 are closed end, hollow tubes rectangular in cross-section and designed to fit and slide freely inside the vertical uprights 22, 26, respectively.

Attached to the lower ends of the vertical uprights 22, 26 are mounting brackets 27, 28, respectively that securely connect the lower ends of the vertical uprights 22, 26, respectively to the lower base 50. The upper frame ember 30 also includes two end transverse members 42, 48 and two intermediate transverse members 44, 46 that attached to the two arms 32, 36 to interconnect and hold them apart.

The apparatus 10 also includes a manual, hydraulic or electric winch 60 attached to the intermediate horizontal support tray 18 attached to the lower frame member 14. The lower frame member 14 includes an upper horizontal support tray 49 to which one pulley 62 is attached. A cable 64 extends upward from the winch 60 and wraps around the pulley 62 and connects to an eyelet formed on the lower end transverse member 42. During use, the operator selectively operates the winch 60 to selectively extend or retract the upper frame member 30 into the lower frame member 14. The winch 60 includes a brake component that holds the upper frame member 30 in a fixed position on the lower frame member 14.

Attached to the upper end of the upper frame member 30 adjacent to the upper end transverse member 48 is a horizontal support member 65. The horizontal support member 65 has a length longer than the width of the frame member 12 so that the ends of the support member 65 extend an equal distance from the sides of the frame member 65. Mounted on the horizontal support member 65 are two drill brackets 70, 70′ each designed to securely hold an electric drill 100, 100′, respectively, in a perpendicular aligned, upward extending position on the support member 65. Each drill bracket 70, 70′ includes a lower flange 71, 71′, a vertical flange 72, 72′, and an upper collar 73, 73′ and configured to hold a vertically aligned drill 100, 100′. The vertical flanges 72, 72′ are attached to an inverted U-shaped bracket 74, 74′, that is fixed to the ends of the horizontal support member 65. When two drills 100 are attached to the two brackets 70, 70′, the drill bits 102, 102′, respectively, used with two drills 100, 100′ are parallel and disposed at the same elevation above the horizontal support member 65. During assembly, the brackets 74, 74 may be selectively moved and locked at a desired position on the horizontal support member 65 thereby enabling the user to adjust the spacing between the two drills 100, 100′.

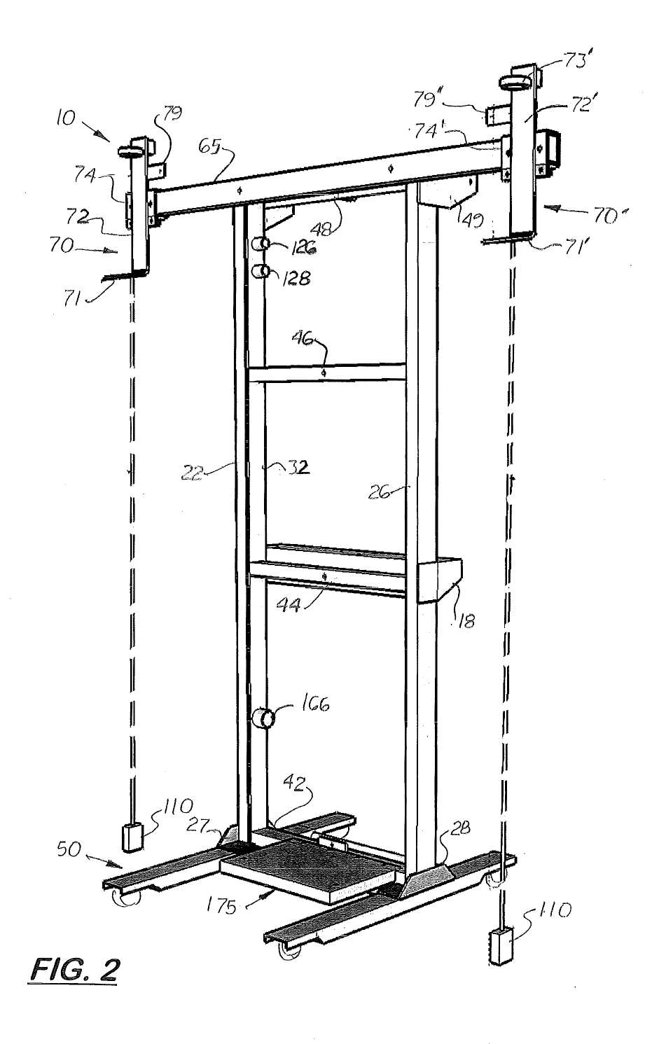

As shown in FIG. 2, the lower flanges 71, 71′ on each bracket 70, 70′, respectively, are sufficient in length and width to act as a reflective surface when a laser pointer 110 is aligned vertically on the ground directly vertically upward and aimed at the lower surface of the flange 71, 71′. A reference point 75 may be marked on the lower surface of the flange 71 that is aligned with the tip of the drill bit 102 when the drill 100 is attached to the drill bracket 70. By marking the desired spot on the flat lower surface, directly under the location of a hole 92 to be drilled on an overhead surface 90, placing a laser pointer 110 aimed upward towards the flange 71, and aligning the drilling apparatus 10 over the laser pointer 110 so that the laser beam shines 112 on the reference point 75 on the flange 71, one or two holes 92 maybe accurately formed on the overhead surface 90 by simply raising the upper frame member 30.

Mounted on the upper ends and on the rear surface of the vertical arms 32, 36 opposite the support member 65 are two optional wheels 86, 88. As shown in FIG. 9, a portion of the rear wheels 52 on the base 50 are exposed so that when the adjustable frame 15 is laid horizontally, the rear pair of wheels 52 and the upper pair wheels 86, 88 enable the operator to roll the apparatus 10 horizontally on its back across a flat floor and then lifted and rotate the apparatus 10 into a vertical position prior to use.

In addition, the drilling apparatus 10 may include an optional vacuum system 160 that includes a vacuum tank 162 mounted on an optional shelf 175 attached to the lower frame member 14. In the embodiment shown herein, the vertical arms 32 and 36 has as conduits that transmit a vacuum to vacuum suction tubes 134, 136 located near the drills. As shown in FIG. 1, the vacuum tank 162 includes a main suction tube 164 that connects to a primary vacuum port 166 formed on the hollow arm 32 of the upper frame member 30. Formed near the upper end of the hollow arm 32 are two vacuum secondary ports 126, 128 that connect to two secondary suction tubes 134, 136, that extend upward and aimed at the drill bits 102, 102′ and used to collect drilling debris. Lateral arms 79, 79′ are attached to the brackets 70, 70′, respectively, to hold the suction tubes 134, 136 in place. In the embodiment presented herein, the vacuum tank 162 mounted on the tray 175 attached to the lower frame member 15. It should be understood however, that the tray 175 may be mounted on the upper frame member 30 thereby enabling it to be lowered and raised

The drilling apparatus 10 may also include a lower electrical receptacle box 145 formed on the opposite leg 26 of the upper frame member 30. The power cords from the vacuum 162 and winch motor 60 are plugged into the lower receptacle box 145. A main power cord 121 extends from the lower receptacle box 145 to a nearby electrical plug in or to an extension cord. Optional wires 180 from the lower receptacle box 145 extend upward through the vertical leg 26 and into the vertical support 36 in the upper frame member 30. A second receptacle box 147 attached to the inside surface of the vertical support 36. During assembly, the powers cords from the two drills 100, 100′ may be plugged into the second receptacle box 147. An optional switch 149 may be mounted on the lower frame and connected to wires that extend from the main power cord 121 to the lower and second receptacle boxes 145, 147, that enables a user to manually and simultaneously activate and deactivate the vacuum and the two drills 100, 100′. The winch 60 includes a separate switch 61 that enables the user to selectively extend or retract the upper frame member 30 into the lower frame member 14.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A drilling apparatus of drilling holes on a raised elevated surface that is located at different heights above a flat support surface, the apparatus comprises:
a. a length adjustable frame that includes a lower frame member and an upper frame member, said lower frame member includes a plurality of wheels that enable said lower frame member to be rolled over a flat support surface, the upper frame member includes an upper end;
b. a support member attached and transversely aligned to the upper end of the upper frame member;
c. at least two drill brackets adjustably attached to the support member, each drill bracket configured to hold a drill in an upward extended position on the support member, at t least one of the brackets includes an outward extending flange surface that is vertically aligned under a center axis of a drill attached to the drill connected to the bracket;
d. an upward extending electric drill attached to each drill bracket; and,
e. a means for longitudinally extending or retracting the upper frame member from the lower frame member.

2. The drilling apparatus as recited in claim 1, wherein the means for longitudinally extending or retracting the upper frame member from the lower frame member is a winch.

3. The drilling apparatus as recited in claim 1, further including a vacuum tank attached to the adjustable frame.

4. The drilling apparatus as recited in claim 2, further including a vacuum tank attached to the adjustable frame.

5. The drilling apparatus as recited in claim 1 further including one or more vacuum hoses attached to the vacuum tank with open nozzle ends that terminate near each drill to removed debris generated by each drill.

6. The drilling apparatus as recited in claim 3, wherein the vacuum tank is connected to ports formed on the legs and arms of the lower and upper frame member that transmit vacuum force to the vacuum tubes.

7. The drilling apparatus as recited in claim 1, wherein the lower frame member is mounted on base attached to wheels.

8. The drilling apparatus as recited in claim 3, wherein the lower frame member is mounted on base attached to wheels.

9. The drilling apparatus as recited in claim 8, further including a pair of wheels attached to the upper end of the lower frame that, the pair of wheels being configured so that the adjustable frame may be transported by rolling the adjustable from in a horizontal orientation on a flat surface and then lifted into a vertical position before final placement.

10. The drilling apparatus as recited in claim 1, further including a reference point on the bottom surface of the flange surface that may be aligned with an upward laser beam generating device position on the flat support surface and aimed at a desired location on an overhead surface to be drilled.

11. The drilling apparatus as recited in claim 1, further including at least one electrical receptacle attached to the adjustable frame.
